(19) United States
(12) Patent Application Publication
(10) Pub. No.: US 2025/0187482 A1
(43) Pub. Date: Jun. 12, 2025

(54) METHOD FOR SECURELY SUPPLYING ENERGY TO VEHICLES

(71) Applicant: Visa International Service Association, San Francisco, CA (US)

(72) Inventors: Brian Sullivan, Amersham (GB); Steven Carrillo, Austin, TX (US); Christian Aabye, Redwood City, CA (US); Cezary Faszczewski, San Francisco, CA (US)

(73) Assignee: Visa International Service Association, San Francisco, CA (US)

(21) Appl. No.: 18/847,524

(22) PCT Filed: Mar. 27, 2023
(86) PCT No.: PCT/US2023/016463

§ 371 Date: Sep. 16, 2024

Related U.S. Application Data
(60) Provisional application No. 63/324,382, filed on Mar. 28, 2022.
(60) Provisional application No. 63/324,565, filed on Mar. 28, 2022.

(51) Int. Cl. B60L 53/66; H04L 9/40

(52) U.S. Cl. CPC B60L 53/665; H04L 63/0428

(57) ABSTRACT

A method is disclosed. It includes establishing a communication session between a vehicle comprising a first processor and an energy supply terminal comprising a second processor. The method includes obtaining, by the first processor in the vehicle, a credential or token, and then generating an encrypted data packet including the credential or token. The method also includes providing the encrypted data packet to the energy supply terminal. The energy supply terminal transmits the encrypted data packet to a service provider computer, which decrypts the encrypted data packet to obtain the credential or token, and then processes a transaction for supplying the vehicle with energy using the credential or the token.

### CROSS-REFERENCES TO RELATED APPLICATIONS

This application is a PCT application which claims priority to and the benefit of U.S. Provisional Application No. 63/324,382, filed on Mar. 28, 2022, and U.S. Provisional Application No. 63/324,565, filed on Mar. 28, 2022, which are herein incorporated by reference in their entirety.

### BACKGROUND

Various methods have been developed to provide energy to vehicles. Such methods often require a user to provide a credential to an energy supply terminal. For example, to purchase gasoline from a gasoline supply terminal (e.g., a gas pump) or to purchase electricity from an electric power terminal, the user needs to provide a secure credential such as a credit or debit card number to the terminal.

Providing the secure credential to the energy supply terminal increases the risk that the secure credential can be stolen by an unauthorized user. For example, some unauthorized users can put skimmers on card readers at the energy supply terminals, and/or can intercept wireless data transmissions between an authorized user device and the energy supply terminal. Further, hackers can hack into the energy supply terminals to obtain the secure credentials. Still further, unscrupulous employees that may have access to the secure credentials can also steal the secure credentials obtained by the energy supply terminals.

Another problem that is present is that there can be many different energy supply terminals. As more payment methods become available, each energy supply terminal needs to be specifically programmed or adapted to process the different payment methods. This situation can be difficult to implement and maintain. Still further, if card credentials are received at an energy supply terminal, the energy supply terminal needs to be PCI-DSS (payments card industry-data security standard) complaint. Maintaining such security compliance across many different types of energy supply terminals is also difficult to implement and maintain.

Another problem is that the current charging infrastructure needs to keep up with continued demand for electric vehicles. The number of electric charging stations needs to increase. Conventional electric charging stations often need expensive components (e.g., card readers) and specialized software (e.g., cryptographic keys to sure payment data) to process payment transactions.

Lastly, yet another issue to be addressed is how much to charge a user when charging their electric vehicle. If a charging station has a card reader on it, the charging station will not know how much to authorize for the transaction since it is unknown how much electricity will be purchased by the user at the time that the charging stations receives the user's credential. While it is possible to “pre-authorize” a standard amount for every electric vehicle (e.g., one hundred dollars) and hold that amount on the user's account (as is currently the practice with gas stations), this practice can unnecessarily and temporarily prevent some users from using funds to which they should otherwise have access.

Embodiments of the invention address these and other problems, individually and collectively.

### SUMMARY

One embodiment of the invention includes a method comprising: a method comprising: establishing a communication session between a vehicle comprising a first processor and an energy supply terminal comprising a second processor; obtaining, by the first processor in the vehicle, a credential or token, generating, by the first processor in the vehicle, an encrypted data packet including the credential or token; and providing, by the first processor in the vehicle, the encrypted data packet to the energy supply terminal, wherein the energy supply terminal transmits the encrypted data packet to a service provider computer, which decrypts the encrypted data packet to obtain the credential or token, and then processes a transaction for supplying the vehicle with energy using the credential or the token.

Another embodiment of the invention includes a vehicle comprising: a first processor; and a computer readable medium, the computer readable medium comprising code executable by the first processor to cause the first processor to perform operations including: establishing a communication session between the vehicle and an energy supply terminal comprising a second processor; obtaining a credential or token, generating an encrypted data packet including the credential or token; and providing the encrypted data packet to the energy supply terminal.

Another embodiment includes a method comprising: receiving, by a service provider computer, an encrypted data packet from a vehicle via an energy supply terminal that supplies energy from the energy supply terminal to the vehicle; decrypting, by the service provider computer, the encrypted data packet to obtain a credential or token; and processing a transaction for supplying the vehicle with the energy using the credential or the token.

Another embodiment includes a service provider computer comprising: a processor; and a computer readable medium, the computer readable medium comprising code, executable by the processor for performing operations comprising: receiving an encrypted data packet from a vehicle via an energy supply terminal; decrypting the encrypted data packet to obtain a credential or token; and processing a transaction for supplying the vehicle with the energy using the credential or the token.

Another embodiment of the invention includes a method comprising: determining, by a processor, a remaining capacity of an energy storage unit in a vehicle; determining, by the processor, a transaction amount needed to fill the remaining capacity of the energy storage unit; generating, by the processor, an authorization request message comprising a token or a credential, and comprising the transaction amount; and transmitting, by the processor, the authorization request message to an authorizing entity computer for authorization.

Another embodiment of the invention includes a computer comprising: a processor; and a computer readable medium coupled to the processor, the computer readable medium comprising code executable by the processor for performing operations comprising: determining a remaining capacity of an energy storage unit in a vehicle; determining a transaction amount needed to fill the remaining capacity of the energy storage unit; generating an authorization request message comprising a token or a credential, and comprising the transaction amount; and transmitting the authorization request message to an authorizing entity computer for authorization.

Another embodiment of the invention includes a method comprising: issuing, by a certificate authority computer to a first sub-entity computer, a first sub-root key pair, wherein the first sub-entity computer thereafter issues a mobility operator electric vehicle digital certificate comprising an electric vehicle public key to an electric vehicle; and issuing, by the certificate authority computer to a second sub-entity computer a second sub-root key pair, wherein the second sub-entity computer thereafter issues a mobility operator service provider digital certificate comprising a service provider public key to a service provider associated with an energy supply terminal.

Another embodiment of the invention includes a certificate authority computer comprising: a processor; and a computer readable medium comprising code, executable by the processor, for performing operations comprising: issuing, to a first sub-entity computer, a first sub-root key pair, wherein the first sub-entity computer thereafter issues a mobility operator electric vehicle digital certificate comprising an electric vehicle public key to an electric vehicle; and issuing, to a second sub-entity computer a second sub-root key pair, wherein the second sub-entity computer thereafter issues a mobility operator service provider digital certificate comprising a service provider public key to a service provider associated with an energy supply terminal.

A better understanding of the nature and advantages of embodiments of the invention may be gained with reference to the following detailed description and accompanying drawings.

### BRIEF DESCRIPTION OF THE DRAWINGS

FIG. 1 shows a block diagram of a system according to an embodiment.

FIG. 2 shows a block diagram of a vehicle according to an embodiment.

FIG. 3 shows a block diagram of supply terminal according to an embodiment.

FIG. 4 shows a block diagram of a service provider computer according to an embodiment.

FIG. 5 shows a block diagram of a user device according to an embodiment.

FIG. 6 shows a block diagram of a certificate distribution system according to an embodiment.

FIG. 7 shows a system diagram illustrating an electric vehicle, supply terminal, and a service provider computer according to an embodiment.

FIG. 8 shows an interaction between a user device and a virtual access device in a vehicle in some embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, rings, bracelets, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A user device may also be a payment device such as a credit, debit, or prepaid card.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

An “application” may be computer code or other data stored on a computer readable medium (e.g., memory element or secure element) that may be executable by a processor to complete a task.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include an encryption key that may be shared openly and publicly. The public key may be designed to be shared and may be configured such that any information encrypted with the public key may only be decrypted using a private key associated with the public key (i.e., a public/private key pair).

A “private key” may include any encryption key that may be protected and secure. A private key may be securely stored at an entity and may be used to decrypt any information that has been encrypted with an associated public key of a public/private key pair associated with the private key.

A “public/private key pair” may refer to a pair of linked cryptographic keys generated by an entity. The public key may be used for public functions such as encrypting a message to send to the entity or for verifying a digital signature which was supposedly made by the entity. The private key, on the other hand may be used for private functions such as decrypting a received message or applying a digital signature. In some embodiments, the public key may be authorized by a body known as a Certification Authority (CA) which stores the public key in a database and distributes it to any other entity which requests it. The private key can typically be kept in a secure storage medium and will usually only be known to the entity. Public and private keys may be in any suitable format, including those based on Rivest-Shamir-Adleman (RSA) or elliptic curve cryptography (ECC).

A “digital signature” may include an electronic signature for a message. A digital signature may be a numeric data value, an alphanumeric data value, or any other type of data. In some embodiments, a digital signature may be a unique data value generated from a message (or data packet) and a private key using a cryptographic algorithm. In some embodiments, a validation algorithm using a public key may be used to verify the signature. A digital signature may be used to demonstrate the veracity of the sender.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to power delivery.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), and the like. An access device may use any suitable contact or contactless mode of operation to send or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided to make a payment from a payment account. Payment credentials can also include a username, an expiration date, a gift card number or code, and any other suitable information.

A “digital signature” may include a type of electronic signature. A digital signature may encrypt documents with digital codes that can be difficult to duplicate. In some embodiments, a digital signature may refer to the result of applying an algorithm based on a public/private key pair, which allows a signing party to manifest, and a verifying party to verify, the authenticity and integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party.

A “certificate” or “digital certificate” may include an electronic document and/or data file. In some cases, the certificate or the digital certificate may be a device certificate. In some embodiments, a digital certificate may use a digital signature to bind a public key with data associated with an identity. A digital certificate may be used to prove the ownership of a public key. The certificate may include one or more data fields, such as the legal name of the identity, a serial number of the certificate, a valid-from and valid-to date for the certificate, certificate related permissions, etc. A certificate may contain a “valid-from” date indicating the first date the certificate is valid, and a “valid-to” date indicating the last date the certificate is valid. A certificate may also contain a hash of the data in the certificate including the data fields. A certificate can be signed by a certificate authority.

A “certificate authority” may include an entity that issues digital certificates. A certificate authority may prove its identity using a certificate authority certificate, which includes the certificate authority's public key. A certificate authority certificate may be signed by another certificate authority's private key or may be signed by the same certificate authority's private key. The latter is known as a self-signed certificate. The certificate authority may maintain a database of all certificates issued by the certificate authority. The certificate authority may maintain a list of revoked certificates. The certificate authority may be operated by an entity, for example, a processing network entity, an issuer, an acquirer, a central bank etc.

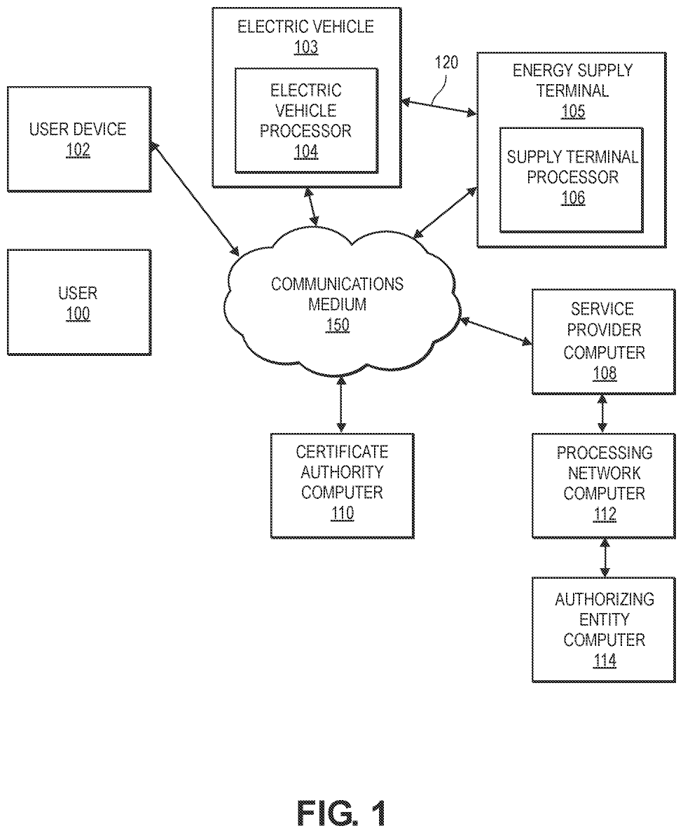

FIG. 1 shows a system according to embodiments. The system can comprise a user 100 that operates a user device 102 and an electric vehicle 103 comprising an electric vehicle processor 104 (which can be an example of a first processor). In some embodiments, the electric vehicle processor 104 can be an electric vehicle communication controller (EVCC).

The system can also include an energy supply terminal 105 (e.g., an electric vehicle charging station) comprising an energy supply terminal processor 106 (which can be an example of a second processor). In some embodiments, the energy supply terminal processor 106 can be a supply equipment communication controller (SECC).

The terms “electric vehicle communication controller (EVCC)” and “supply equipment communication controller (SECC)” are from ISO 15118. ISO 15118 is one of the International Electrotechnical Commission's (IEC) group of standards for electric road vehicles and electric industrial trucks. ISO 15118 is a proposed international standard defining a vehicle to grid (V2G) communication interface for bi-directional charging/discharging of electric vehicles.

A cable 120 can be attached to the energy supply terminal 105 and can physically and communicatively connect the electric vehicle and the energy supply terminal 105. In some embodiments, the cable 120 is an electric charging cable adapted to charge an electric car or other electric vehicle 103. In some embodiments, the energy supply terminal 105 and the electric vehicle 103 can communicate through a protocol such as ISO 15118.

In other embodiments, the cable 120 is not necessary where other energy supply mechanisms can be used. For example, the electric vehicle 103 can receive energy (e.g., electricity) from the energy supply terminal 105 via induction, which would not require the use of a physical charging cable. Communications passing between the energy supply terminal 105 and the electric vehicle 103 can occur via another wireless protocol such as Bluetooth™ or Wi-Fi™.

The system can further include a service provider computer 108 operated by a service provider and a certificate authority computer 110 operated by a certificate authority. The system may further include transaction processing subsystem which can include a processing network computer 112 in a processing network such as a payment processing network, and an authorizing entity computer 114, which may be in communication with the service provider computer 108. In some embodiments, an entity that operates the payment processing network can be referred to as a “mobility operator.”

The electrical components (e.g., the computers) in the system of FIG. 1 and any of the following figures can be in operative communication with each other through any suitable communications medium 150. Suitable examples of the communications medium 150 may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); and Secure Hypertext Transfer Protocol (HTTPS).

In some embodiments, the service provider operating the service provider computer 108 may be a service provider that can provide charging services to users. It may alternatively be an entity (e.g., a payment processor) that performs services on behalf of the service provider that provides charging services. Examples of the service providers can include charge point operators, electric vehicle manufacturers, payment processors such as payment service providers, etc.

In some embodiments, the user 100 may communicate with the service provider computer 108 to establish a service provider account if the user 110 has a preexisting relationship with the service provider. In some cases, the service provider account may be used to obtain electricity from the energy supply terminal 105. In some embodiments, the service provider account may be identified by a service provider account number such as eMobility account ID (eMAID). In other embodiments, the service provider operating the service provider computer 108 may not have a pre-existing relationship with the user 100.

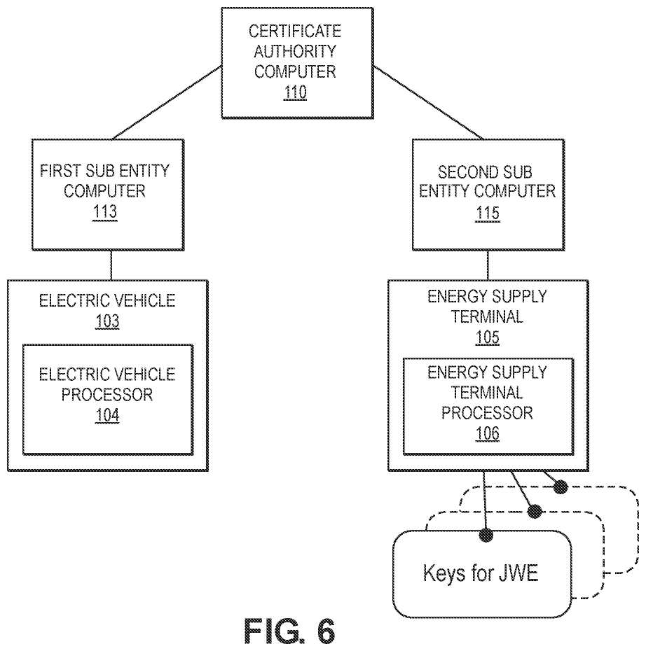

The certificate authority computer 110 may provide digital certificates to one or more of the other devices in FIG. 1. For example, the certificate authority computer 110 may provide sub-certificate authorities (e.g., mobility operators or other entities) with sub-root keys. The sub-certificate authorities can provide certificates to various entities. In some embodiments, a sub-certificate authority can issue a mobility operator electric vehicle digital certificate to an electric vehicle. Another sub-certificate authority can issue a mobility operator service provider digital certificate to a service provider operating a service provider computer. The mobility operator electric vehicle digital certificate and the mobility operator service provider digital certificate can originate from a mobility operator. An example of such a digital certificate system including a certificate authority computer is shown in FIG. 6.

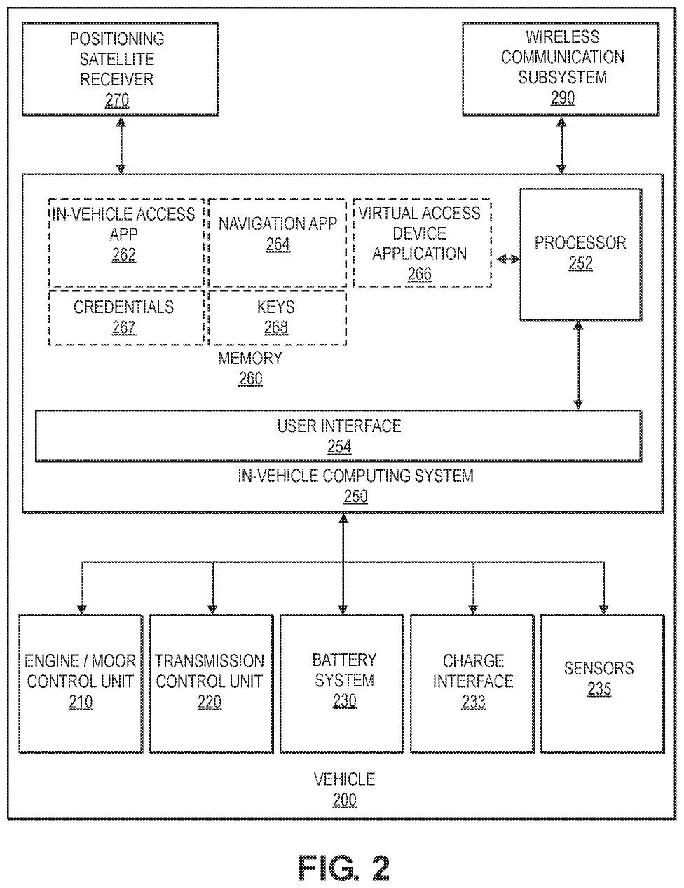

FIG. 2 illustrates a block diagram of a vehicle 200, according to some embodiments. Vehicle 200 can be, for example, an electric vehicle. Although vehicle 200 may be described as an automobile, it should be understood that in some embodiments, the techniques described herein can also be applied to other types of vehicles such as motorcycles, boats, aircrafts, or other types of powered machines that are used to transport a user from one location to another.

Vehicle 200 may include various electronic control units (ECUs) to operate and control the electrical system or other subsystems of vehicle 200, and may include sensors 235 that the ECUs can monitor. Each ECU may include a microcontroller and one or more memories (e.g., any combination of SRAM, EEPROM, Flash memories, etc.) to store one or more executable programs for the ECU. Examples of ECUs may include engine/motor control unit 210, transmission control unit 220, etc. In some embodiments, vehicle 200 may include additional ECU(s) not specifically shown, omit one or more ECUs, and/or integrate any of the functionalities of different ECUs into a single ECU.

Vehicle 200 can also include a battery system 230 comprising one or more batteries and a charge interface 233 for charging the one or more batteries. The battery system 230 and the charge interface 233 can be in communication with and coupled to the in-vehicle computing system 250 and its processor 252.

Engine/motor control unit 210 may control the actuators, valves, motor, and/or other components of the engine of vehicle 200, or an electric motor of the vehicle 200. Transmission control unit 220 may control the gear shifting and the transmission modes (e.g., park, drive, neutral, reverse) of vehicle 200. Battery system 230 may include electronics that can control the electrical voltage and current supplied by its one or more batteries to the various components of vehicle 200. Sensors 235 may include vehicle speed sensors (e.g., wheel sensors) to detect the speed of vehicle 200, temperature sensors to detect the operating temperature of the vehicle's various components, air sensors to detect oxygen level in the engine, sensors to detect the amount of energy currently (e.g., electricity, gas, etc.) present with the vehicle or the available capacity of any energy storage devices such batteries, cameras to observe the surroundings of vehicle 200, etc. The various ECUs, devices, and sensors may communicate with one another via a vehicle communication bus 240. Examples of vehicle communication bus 240 may include a controller area network (CAN) bus, a local interconnect network (LIN) bus, a vehicle area network (VAN) bus, or other suitable signal buses for vehicle communication.

Vehicle 200 may also include various radio frequency (RF) transceivers to allow vehicle 200 to receive and transmit RF signals with other devices. For example, vehicle 200 may include a positioning satellite receiver 170 such as a GPS receiver to receive satellite signals that can be demodulated and decoded to determine the location of vehicle 200. The positioning satellite receiver 270 can be used by a positioning or navigation subsystem of vehicle 200 to perform routing and mapping functions.

Vehicle 200 may also include a wireless communication subsystem 290 to enable network connectivity for vehicle 200. Wireless communication subsystem 290 may include one or more wireless transceivers that use WiFi, WiMax, or other types of wireless network communication protocols to connect vehicle 200 to an external network (e.g., the Internet) such that vehicle 200 can communicate with remote servers. Wireless communication subsystem 290 may also include one or more short or near range wireless transceivers such as RFID, Bluetooth or Bluetooth Low Energy, NFC, beacon, infrared transmitters and/or receivers that can be used to communicate with an access device in proximity to vehicle 200.

Vehicle 200 may also include an in-vehicle computing system 250 with which a user of vehicle 200 can interact. In-vehicle computing system 250 can be an infosystem, infotainment system, or other instrumentation system. In-vehicle computing system 250 can be mounted in the center console, dashboard, rear console, or other locations in vehicle 200 that is convenient for a user to access in-vehicle computing system 250. In some embodiments, in-vehicle computing system 250 can be coupled to vehicle communication bus 240 to receive vehicle status information from the ECUs and sensors 235.

In-vehicle computing system 250 may include a processor 252, a memory 260, and user interface 254. User interface 254 may include an input interface such as any number of buttons, knobs, microphone and/or a touchscreen that can receive user input, and an output interface such as a display (may be part of a touchscreen) and/or speakers. The display of user interface 254 can be integrated with the housing of in-vehicle computing system 250, or can be a separate component coupled to in-vehicle computing system 250 but mounted at a different location than in-vehicle computing system 250. For example, the display of user interface 254 can be mounted on the surface of the center console, on the dashboard, on the surface of the rear console, behind the headrest, on the interior ceiling, on the visor, or other suitable location in vehicle, and may display various types of information including information such as vehicle status information (e.g., speed, fuel economy, engine temperature, etc.), environmental information (e.g., inside/outside temperature, weather, etc.), navigation information (e.g., maps, routes, places of interests, etc.), entertainment such as videos or titles of audio selections or radio stations, energy level information (e.g., amount of charge present and needed to fill to capacity, amount of gas present and needed to fill to capacity), transaction information, energy terminal information, etc.

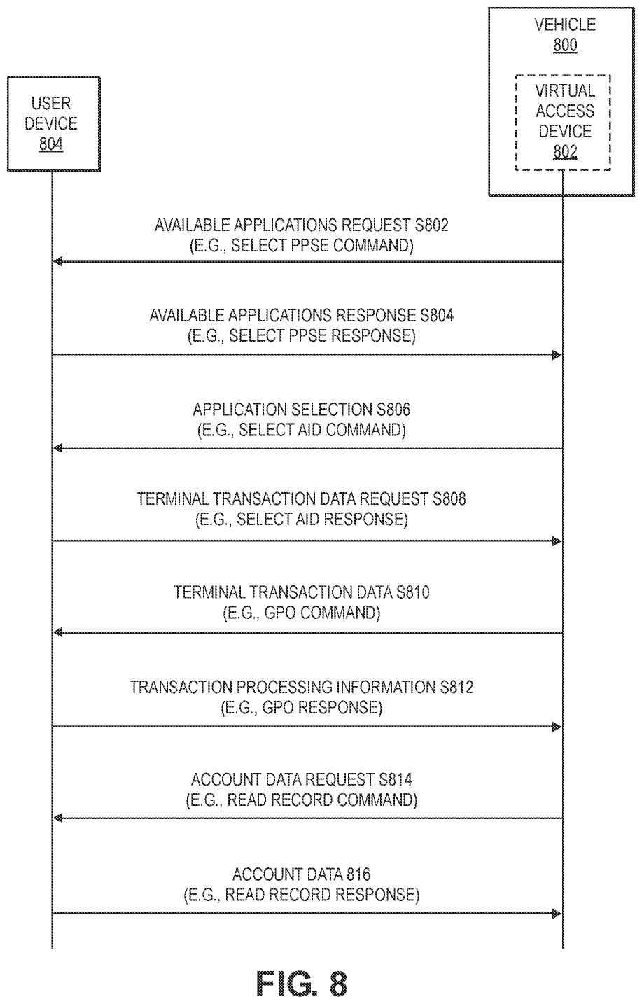

Memory 260 may include any combination of SRAM, DRAM, EEPROM, Flash, and/or other types of memories, etc. Memory 260 may store a number of applications such as in-vehicle access application 262, navigation application 264, a virtual access device application 266, and/or other applications not specifically shown such as a climate control application. The virtual access device application 266 can include code executable by the processor 252 to emulate an access device such as a point of sale terminal. Some functions programmed into the virtual access device application 266 are described below in the description of FIG. 8.

Navigation application 264 can be part of a positioning or navigation subsystem of vehicle 200, and may provide navigation functionalities such as mapping and routing functions. A user of vehicle 200 may input a desired location into in-vehicle computing system 250, and navigation application 264 can determine a current location of vehicle 200 using a positioning satellite receive 270, and provide directions to travel to the desired location. Navigation application 264 may display a map on user interface 254 and highlight a route to a desired destination. Navigation application 264 may also display nearby places of interests and/or nearby merchants on user interface 254.

In-vehicle access application 262 enables in-vehicle computing system 250 to access resources for the vehicle 200. In some scenarios, in-vehicle access application 262 may allow a user of vehicle 200 to execute a transaction with a resource provider computer without requiring the user to exit vehicle 200, and without requiring the user to use another device such as the user's payment card or mobile device. In-vehicle access application 262 may store account credentials 267 or tokens, or reference identifiers thereof for various accounts, allow a user to select a particular account, and transmit the account credentials or tokens (or references identifiers thereof) associated with the selected account to a user device and/or server upon approval by the user. The memory 260 can also comprise cryptographic keys 268 can be used to encrypt data, sign data, verify data, etc.

The memory 260 can comprise a computer readable medium. The computer readable medium may comprise code, executable by the processor 252 to perform operations comprising: establishing a communication session between the vehicle and an energy supply terminal comprising a second processor; obtaining a credential or token; generating an encrypted data packet including the credential or token; and providing the encrypted data packet to the energy supply terminal.

The computer readable medium in the memory 260 may also comprise code, executable by the processor 252 to perform operations comprising: determining a remaining capacity of an energy storage unit in a vehicle; determining a transaction amount needed to fill the remaining capacity of the energy storage unit; generating an authorization request message comprising a token or a credential, and comprising the transaction amount; and transmitting the authorization request message to an authorizing entity computer for authorization

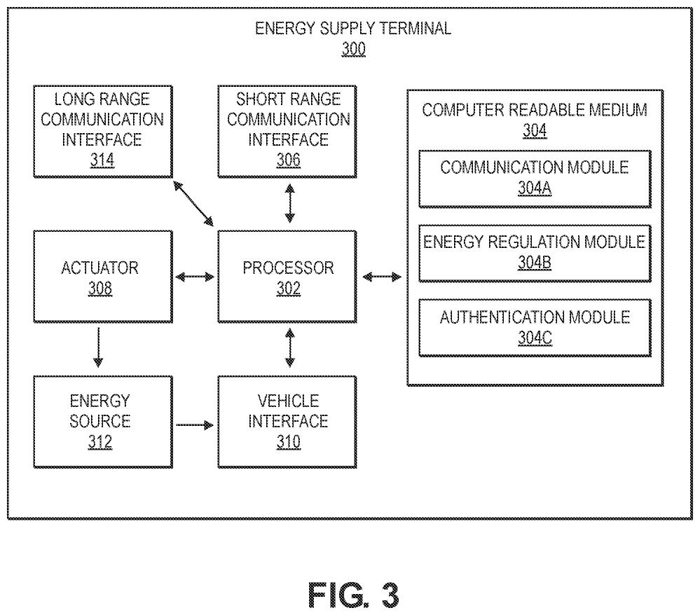

FIG. 3 shows a block diagram of an energy supply terminal 80 according to an embodiment. The energy supply terminal 80 can comprise a processor 302. The energy supply terminal may also comprise a computer readable medium 304, a short range communication interface 306, an actuator 308, a vehicle interface 310, and a long range communication interface 314 coupled to the processor 302. An energy source 312 can be coupled to the actuator 308 and the vehicle interface 310. The actuator 308 may be a pump or switch (e.g., an electrical or mechanical switch) that allows the energy source 312 to provide energy to the vehicle interface 310 and then to a connected vehicle. The energy source 312 could be an electrical line or conduit, or it could be a fuel tank.

The computer readable medium 304 may further comprise a communication module 304A, an energy regulation module 304B, and an authentication module 304C. The communication module 304A can include code, executable by the processor 302 to allow the energy supply terminal 80 to communicate with external devices such as a vehicle or remote computer such as the previously described terminal support computer 70. The energy regulation module 304B and the processor 302 can determine how much energy is needed or should be provided to a vehicle, and can control the actuator 308 to control the flow of energy to the vehicle interface 310 and to the connected vehicle. The authentication module 304C can be used to authenticate a user and/or a vehicle that may be connected to the energy supply terminal 80.

The computer readable medium 304 may further comprise code, which when executed by the processor 302, causes the processor to perform operations comprising: establishing a communication session between a vehicle comprising a first processor and an energy supply terminal comprising a second processor; receiving, by the energy supply terminal from the vehicle, an encrypted data packet including the credential or token; and transmitting, by the energy supply terminal to a service provider computer, the encrypted data packet, which decrypts the encrypted data packet to obtain the credential or token, and then processes a transaction for supplying the vehicle with energy using the credential or the token.

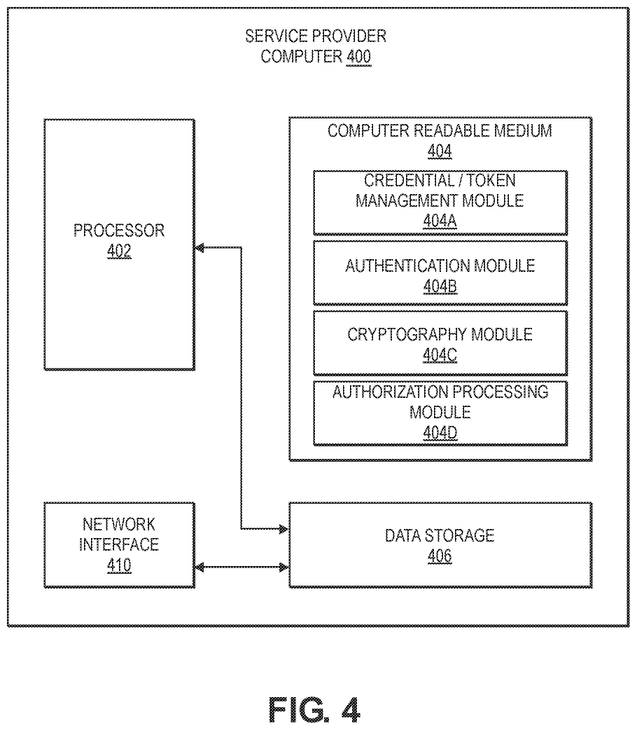

FIG. 4 shows a block diagram of service provider computer 400 according to an embodiment. The service provider computer 400 can comprise a processor 402, which may be coupled to a data storage 406 and a network interface 408. A computer readable medium 404 may also be operatively coupled to the processor 402. The data storage 406 can store any suitable data including but not limited to credentials and/or tokens, references to credentials and/or tokens, user data (e.g., usernames) or vehicle data (e.g., VINs) associated with the credentials or tokens, etc.

The computer readable medium 404 may comprise a number of software modules including a credential/token management module 404A, an authentication module 404B, and an authorization processing module 404D.

The credential/token management module 404A may comprise code that causes the processor 402 to retrieve credentials or tokens from the data storage 406 in response to receiving credential or token identifiers. The credential/token management module 404A may also comprise code that causes the processor 402 to receive and store credentials and/or tokens in the data storage 406.

The authentication module 404B may comprise code that causes the processor 402 to authenticate users, user devices, or vehicles used by users, before processing transactions.

The cryptography module 404C may comprise code that causes the processor 402 to perform cryptographic operations including encryption, decryption, hashing, signing, signature verification, key generation, etc.

The authorization processing module 404D may comprise code that causes the processor 402 to perform authorization processing. Authorization processing can include generating and transmitting authorization request messages or providing instructions to generate and transmit authorization request messages, receive authorization response messages, and generate notifications relating to transaction authorizations or declines. Authorizing processing can also including gathering data for an authorization and transmitting it to another computer.

The computer readable medium 404 may also comprise code, executable by the processor 402 to perform operations comprising: receiving, by a service provider computer, an encrypted data packet from a vehicle via an energy supply terminal; decrypting, by the service provider computer, the encrypted data packet to obtain a credential or token; and processing a transaction for supplying the vehicle with the energy using the credential or the token.

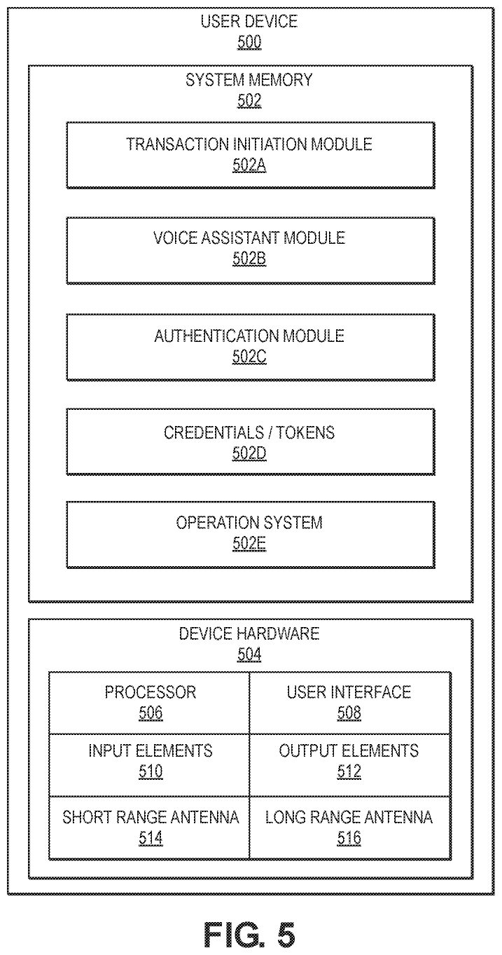

FIG. 5 shows a block diagram of a user device 500 in according to an embodiment. The user device 500 may include device hardware 504 coupled to a system memory 502.

Device hardware 504 may include a processor 506, a short range antenna 514, a long range antenna 516, input elements 510, a user interface 508, and output elements 512 (which may be part of the user interface 508). Examples of input elements may include microphones, keypads, touchscreens, sensors, etc. Examples of output elements may include speakers, display screens, and tactile devices.

The long range antenna 516 may include one or more RF transceivers and/or connectors that can be used by user device 500 to communicate with other devices and/or to connect with external networks. The user interface 508 can include any combination of input and output elements to allow a user to interact with and invoke the functionalities of user device 500. The short range antenna 509 may be configured to communicate with external entities through a short range communication medium (e.g., using Bluetooth, Wi-Fi, infrared, NFC, etc.). The long range antenna 819 may be configured to communicate with a remote base station and a remote cellular or data network, over the air.

The system memory 502 can be implemented using any combination of any number of non-volatile memories (e.g., flash memory) and volatile memories (e.g., DRAM, SRAM), or any other non-transitory storage medium, or a combination thereof media.

The system memory 502 may also store a transaction initiation module 502A, a voice assistant module 502B, an authentication module 502C, credentials and/or tokens 502D, and an operating system 502E, The transaction initiation module 502A may include instructions or code initiating and conducting a transaction with an external device such as an access device or a processing computer. It may include code, executable by the processor 506, for generating and transmitting authorization request messages, as well as receiving and forwarding authorization response messages. It may also include code, executable by the processor 506, for forming a local connection or otherwise interacting with an external device (e.g., an Operator computer). The voice assistant module 502B may comprise code, executable by the processor 506, to receive voice segments, and generate and analyze data corresponding to the voice segments. The authentication module 502C may comprise code, executable by the processor 506, to authenticate a user. This can be performed using user secrets (e.g., passwords) or user biometrics. System memory 502 may also store credentials and/or tokens or references to credentials and/or tokens 502D.

FIG. 6 shows a digital certificate structure according to embodiments. The certificate authority computer 110 operated by the certificate authority may store a root certificate. The root certificate may be a digital certificate associated with a root public key and a root private key. The certificate authority computer 110 may issue sub-root keys to a one or more sub-entities, which may include the organization that operates the certificate authority root, and/or third parties authorized by the certificate authority to operate as a sub-certificate authority.

FIG. 6 shows examples of sub-entity computers including a first sub-entity computer 113 operated by a first sub-entity (e.g., a service provider, a manufacturer, etc.), and a second sub-entity computer 108 operated by a second sub-entity. For example, the certificate authority computer 110 may issue a first sub-root key pair to the first sub-entity computer 113 and can allow the first sub-entity operating the first sub-entity computer 113 to issue electric vehicle digital certificates (or “contract certificates” pursuant to ISO 15118) to electric vehicles. For example, the first sub-entity computer 113 may be operated by a mobility operator or a delegate of the mobility operator, and may issue a mobility operator electric vehicle digital certificate to the electric vehicle 103. The mobility operator electric vehicle digital certificate may comprise the electric vehicle public key, and the certificate or components thereof may be signed with a private key of the first sub-root key pair. An external entity may verify the mobility operator electric vehicle digital certificate by accessing the public key of the first sub-root key pair to validate the signed mobility operator electric vehicle digital certificate. The electric vehicle 103 may also be provisioned with the root certificate from the certificate authority computer 110. The root certificate can be used by an external entity to validate the first sub-entity computer 108 that issued the mobility operator electric vehicle digital certificate and that the mobility operator electric vehicle digital certificate is otherwise in good standing.

A similar process may be performed between the certificate authority computer 110 and the second sub-entity computer 115. In some embodiments, the second sub-entity computer 115 may be operated by a mobility operator or a delegate of the mobility operator. For example, the certificate authority computer 110 may issue a second sub-root key to the second sub-entity computer 115. The sub-entity computer may issue a mobility operator service provider digital certificate (e.g., a mobility operator payment service provider digital certificate) to a service provider that operates the energy supply terminal 105. The mobility operator service provider digital certificate may comprise a service provider public key. The mobility operator service provider digital certificate or components thereof may be signed with a private key of the second sub-root key pair. The mobility operator service provider digital certificates can be loaded into the energy supply terminals in the system. The energy supply terminals can be part of a charging network that work in conjunction with the service provider (e.g., charging network, a payment service provider, etc.). In some embodiments, the mobility operator service provider digital certificate can be transferred from the energy supply terminal 105 to the electric vehicle 103 during a charging session. The electric vehicle 103 uses the mobility operator service provider digital certificate (after authenticating with the certificate authority root, which will have been pre-installed) to generate session-unique keys that are used to create an encrypted package of data that can only be decrypted by the service provider to which the second sub-entity computer 115 had issued the mobility operator service provider certificate.

The certificate hierarchy illustrated in FIG. 6 can allow any electric vehicle to trust an energy supply terminal, and any energy supply terminal to trust any electric vehicle, since the certificates for those entities can correspond to the root public key and the root certificate of the certificate authority computer 110. For example, before the electric vehicle 103 transmits sensitive data (such as a credential or token) to the energy supply terminal 105, the electric vehicle processor 104 can receive the mobility operator service provider digital certificate of the energy supply terminal 105 and can validate digital signatures of both the second sub entity computer 115 and the certificate authority computer 110.

Stated differently, the certificate hierarchy illustrated in FIG. 6 can allow any electric vehicle to trust an energy supply terminal, and any energy supply terminal to trust any electric vehicle, since the certificates for those entities can correspond to the root public key and the root certificate of the certificate authority computer 110. In accordance with ISO15118, the electric vehicle certificates (left branch) can be used to sign messages originating from the electric vehicle 103 (which can be authenticated by the energy supply terminal 105 (which has the root certificate authority key of the certificate authority computer 110). In addition to the functionality described in ISO15118, the service provider certificate can be authenticated by the electric vehicle 103 (which has the root certificate authority key of the certificate authority computer 110), prior to creating the encrypted JWE that contains sensitive card data.

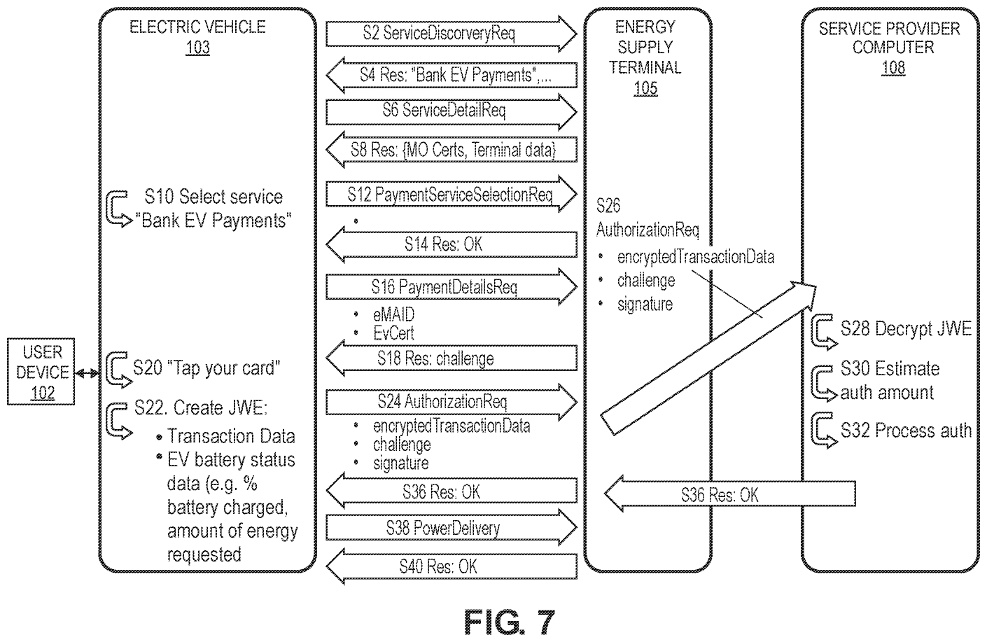

FIG. 7 shows a diagram and overlaid process flow for power delivery according to embodiments. The processes shown in FIG. 7 may be performed by the electric vehicle 103, the energy supply terminal 105 (e.g., a charging station) and the service provider computer 108. The processes may include explicit interactions with the user 100, or may be completed automatically without the need for direct user involvement.

The user 100 can manipulate a charge cable attached to the energy supply terminal 105 and plug it into the electric vehicle 103. A communication session can then be established between the electric vehicle 103, which may comprise a first processor and the energy supply terminal 105, which may comprise a second processor via the charging cable. The charging cable is adapted to supply energy from the energy supply terminal 105 to the electric vehicle 103. The first processor in the electric vehicle 103 and the second processor in the energy supply terminal 105 can communicate using a protocol such as ISO 15118 (e.g., ISO 15118-2 or ISO 15118-20). The actions described below with respect to the electric vehicle 103 and the energy supply terminal 105 can be performed by the first processor, and the second processor, respectively.

At step S2, the electric vehicle 103 may transmit a service discovery request to the energy supply terminal 105. The service discovery request may request a list of services available at the energy supply terminal 105.

In step S4, after receiving the service discovery request from the electric vehicle 103, the energy supply terminal 105 may transmit a service discovery response comprising a list of available services to the electric vehicle 103. For example, the energy supply terminal 105 may indicate that a number of applications including an electric vehicle payments application are available.

At step S6, after receiving the service discovery response from the energy supply terminal 105, the electric vehicle 103 may determine a set of services from the list of available services that it supports. After the electric vehicle 103 determines the set of services that is supports, the electric vehicle 103 can then transmit a service detail request to the energy supply terminal 105. The service detail request may request details associated with one or more services that are compatible with the electric vehicle 103. In some embodiments, the service detail request may comprise indicators for the one or more compatible services.

In step S8, after receiving the service detail request from the electric vehicle 103, the energy supply terminal 105 may transmit a service detail response to the electric vehicle 103. The service detail response can comprise energy supply terminal data (e.g., a terminal identifier) and a mobility operator service provider digital certificate associated with the service provider computer 108 and issued by a mobility operator (e.g., such as the above described certificate authority, or sub-authority). The mobility operator service provider digital certificate can comprise a public key associated with private key stored at the service provider computer 108 that services a charging network including the energy supply terminal 105. The mobility operator service provider digital certificate can also include other data such as the data described above under the term “digital certificate” including the name of the service provider, an issuance date, an expiration date, and a digital signature. The electric vehicle 103 can also validate the mobility operator service provider digital certificate by verifying the certificate chain to the certificate authority root, and by determining if it is not expired.

Stated differently, the electric vehicle 103 will have an integrity-checked copy of the certificate authority root certificate that was previously installed (this could happen during manufacturing, or some point after manufacturing). As described above, the electric vehicle 103 will receive a mobility operator service provider digital certificate in the service detail response. If a sub-certificate authority has been used, then the mobility operator service provider digital certificate will comprise a service provider leaf certificate and a sub-certificate authority certificate. If a sub-certificate authority has not been used, then the mobility operator service provider digital certificate will just contain the service provider leaf certificate. The electric vehicle 103 can verify the certificate chain of the service provider certificate. For example, if a sub-certificate authority ID is present, then the electric vehicle 103 can authenticate the service provider leaf certificate with the sub-certificate authority, and then the electric vehicle 103 can authenticate the sub-certificate authority certificate with the certificate authority root. If there is no sub-certificate authority certificate, then the electric vehicle 103 can authenticate the service provider leaf certificate directly with the sub-certificate authority.

In step S10, the electric vehicle 103 may prompt the user to select one or more services (e.g., via a display on the electric vehicle 103, via the user device 102, etc.) from the set of services that are compatible with both the electric vehicle 103 and the energy supply terminal 105. Alternatively, this selection could be performed automatically by the electric vehicle 100 based on pre-established consumer preferences.

In step S12, after receiving the service detail response from the energy supply terminal 105, the electric vehicle 103 may transmit an interaction service selection request comprising the selected service(s) to the energy supply terminal 105. In some embodiments, the selected service can be a particular payment service application.

In step S14, after receiving the interaction service selection request from the electric vehicle 103, the energy supply terminal 105 may transmit an interaction service selection response to the electric vehicle 103. The interaction service selection response may verify the service selection.

At step S16, after receiving the interaction service selection response from the energy supply terminal 105, the electric vehicle 103 may transmit an interaction details request comprising a mobility operator electric vehicle digital certificate to the energy supply terminal 105. In some cases, a contract identifier such as an eMAID may also be present in the interaction details request. The eMAID can identify a contract that is associated with the electric vehicle 103 to the energy supply terminal 105. In some cases, the contract identifier can cause the energy supply terminal 105 to provide specific services to the user of the electric vehicle 103 as a result of the transaction (e.g., rewards, data collection, etc.).

At step S18, after receiving the interaction details request from the electric vehicle 103, the energy supply terminal 105 may verify the mobility operator electric vehicle digital certificate to determine that it is valid. For example, the energy supply terminal 105 can validate the signatures of a certificate authority computer and any sub-certificate authority computer using the appropriate public keys and may also verify that the certificate is not expired. If the energy supply terminal 105 determines that the mobility operator electric vehicle digital certificate is valid, then it can transmit an interaction details response comprising a challenge to the electric vehicle 103. In some embodiments, the challenge may be a string of random numbers. The electric vehicle 103 may thereafter form a signed challenge by signing the challenge using a private key associated with a public key in the mobility operator electric vehicle digital certificate.

At step S20, before or after signing the challenge to form a signed challenge, the electric vehicle 103 may provide an interaction data request to the user operating the user device 102. The interaction data request may prompt the user (e.g., via a user interface in the electric vehicle 103 or through a mobile phone of the user) to interact the user device 102 with a reader on the electric vehicle 103, so that the electric vehicle 103 can obtain a credential or token from the user device 102. For example, the user device 102 may be a credit card, and a reader in the electric vehicle 103 may be a contact or contactless card reader (e.g., an NFC reader). The reader in the electric vehicle 103 can read the credential or token from a memory in the user device 102.

In other embodiments, the user need not interact the user device 102 with the electric vehicle 103. The credential or the token can be stored in a memory (such as a secure element) in the electric vehicle 103 and can be obtained from the memory.

In other embodiments, the user may choose a payment credential or token on their mobile phone which may be attached to the electric vehicle 103 using Bluetooth, Wi-Fi or a physical cable. In this case, the credential or token could be obtained from the memory of the mobile phone, or may be retrieved by the phone from some Internet based service which may be identified using configuration data received from the energy supply terminal 105 in S8.

In some embodiments, in response to receiving the interaction details request, the electric vehicle 103 can determine an amount of charge needed to fill the battery in the electric vehicle 103 with electricity. For example, the electric vehicle 103 can determine the amount of battery capacity that is available in the battery of the electric vehicle 103 and can determine the amount of electricity needed to fill it.

At step S22, the electric vehicle 103 can generate an encrypted data packet by encrypting interaction data including at least the credential or token, and (optionally) the amount of electricity needed to fully charge the battery of the electric vehicle 103, with a session key derived using an algorithm such as Elliptic Curve-Diffie Hellman, with the service provider public key obtained from the mobility operator service provider digital certificate. Prior to doing so, the electric vehicle 103 can verify that the mobility operator service provider digital certificate is valid and authentic. In some embodiments, JWE (JSON Web Encryption) can be used. Then, an authorization request message comprising the encrypted data packet, the challenge, and the signed challenge may be generated by the electric vehicle 103 and then transmitted to the energy supply terminal 105 in step S24. The message that is used to transmit the encrypted data packet, the challenge received in S18, and the signed challenge can be in a data format compatible with ISO 15118.

At step S26, after receiving the authorization request message from the electric vehicle 103, the energy supply terminal 105 may verify the signed challenge using the public key in the mobility operator electric vehicle digital certificate. Once the signed challenge is verified, the energy supply terminal 105 can transmit the authorization request message to the service provider computer 108. In other embodiments, the signed challenge could be verified by the service provider computer 108 instead of the energy supply terminal 105.

At step S28, the service provider computer 108 can decrypt the encrypted interaction data using a session key derived using an algorithm such as Elliptic Curve-Diffie Hellman with the private key of the service provider computer 108 and the data supplied with the JWE created by the electric vehicle 103 to obtain the credential or token, and the amount of electricity needed to fully charge the battery of the electric vehicle 103. The service provider computer 108 can then process a transaction for supplying the electric vehicle with electricity using at least the credential or the token.

In step S30, the service provider computer 108 can estimate an amount of the transaction using the amount of electricity in the authorization request message. In some embodiments, the service provider computer 108 can store a conversion table which correlates amounts of electricity with various costs, or it can store a conversion factor which allows the service provider computer 108 to calculate a cost based upon an amount of electricity. In other embodiments, the amount of the transaction can simply be a fixed cost, which would cover fully charging any vehicle battery from empty.

More specifically, in some embodiments, if the amount of the electrical charge obtained by the user is not yet known when the user provides an account number to the energy supply terminal 105, the service provider computer 108 may then determine a pre-authorization amount (e.g., an amount of funds to be reserved for payment of charging the electric vehicle 103). The service provider computer 108 may determine the pre-authorization amount after receiving and determining the information regarding the percent battery charge amount requested or needed to fully charge the battery in the electric vehicle 103. For example, the current cost per kilowatt hour can be multiplied by the amount of estimated charged needed to determine the pre-authorization amount. For instance, the service provider computer 108 may determine that the pre-authorization amount is $20.00, since the battery in the electric vehicle is 50% full and has 50% capacity to charge. The pre-authorization amount may be included with a token or credential in an authorization request message. The service provider computer 108 may then process the authorization request message, which may include communicating with a payment processing network to authorize a payment. After the authorization request is processed, the service provider computer 108 may transmit an authorization response to the energy supply terminal 105 (e.g., which indicates if the interaction is authorized or is not authorized). The amount of the authorization request is then held in the user's account. After the charging of the electric vehicle 103 is completed, the cost of the charge is later determined by the service provider computer 108 and a subsequent message (e.g., another authorization or clearing message) may be sent to the authorizing entity computer with the actual cost of the charge, and the previous hold may be released. For example, if $20 was held and the actual cost of the charge was $10, then the hold on the remaining $10 is released.

In other embodiments, if the amount of electrical charge is known, then the transaction amount for that charge is included in an authorization request message with the credential or token.

The authorization request message generated by the service provider computer 108 may also be converted to a different data format (e.g., from ISO 15118 or XML type data format to ISO 8583). The service provider computer 108 may then process the authorization request message, which may include communicating with a processing network computer 112 and an authorizing entity computer 114 to authorize a payment. After the authorization request is processed, the service provider computer 108 may receive an authorization response indicating whether or not the transaction is authorized from the processing network computer 112 and the authorizing entity computer 114.

In step S32, the service provider computer 108 can transmit the authorization request message to an authorizing entity computer 114 operated by an issuer (e.g., via a transport computer operated by an acquirer and a processing network computer 112 operated by a payment processing network) of an account associated with the credential or the token. The authorization request message may be converted to a different data format such as an ISO 8583 type data format. The authorizing entity computer 114 can authorize or decline the transaction and can transmit an authorization response message with the authorization decision back to the service provider computer 108.

If the authorization request message comprises a token, instead of a credential such as a PAN, the processing network computer 112 can detokenize the token into a real PAN and can replace the token with the real PAN before transmitting the authorization request message to the authorizing entity computer 114.

In step S34, after receiving the authorization response message, the service provider computer 108 and provide the authorization response message or may provide an authorization respond message in a different data format back to the energy supply terminal 105. The authorization response message may then be transmitted to the electric vehicle 103 in step S36.

At step S38, after receiving the authorization response from the energy supply terminal 105, the electric vehicle 103 may transmit a power delivery request to the energy supply terminal 105. The power delivery request may be a request to charge the electric vehicle 103.

In step S40, after receiving the power delivery request from the electric vehicle 103, the energy supply terminal 105 may transmit a power delivery response to the electric vehicle 103. After receiving the power delivery response from the energy supply terminal 105, the electric vehicle 103 may receive power from the energy supply terminal 105.

In some embodiments, a clearing and settlement process can be performed between a payment processing network, an acquirer of the service provider computer, and an issuer of the credential after the electric vehicle has been charged.

If the authorization request message to the authorizing entity computer was a pre-authorization request message, then the actual cost of the amount of electricity obtained by the electric vehicle 103 can be included in a subsequent authorization request with the actual amount can be submitted by the service provider computer 108 and any hold on the user's account as a result of the pre-authorization request message processing can be released.

Although the use of the above-described pre-authorization process is described in the context of an electric car with an energy storage unit in the form of a battery, it is understood that embodiments of the invention can be used in other contexts. For example, the energy storage unit may be a gas tank in a car. In such embodiments, the car may send a signal to a gas pump (e.g., via a short-range wireless communication or via the gas pump) indicating how full the car's gas tank is and indicating the storage capacity of the gas tank. The gas pump can determine how much gas would be needed to fill the gas tank. The gas pump could then send a pre-authorization to an authorizing entity computer operated by an issuer of the user's payment device for that amount for authorization. The hold and release process would be similar to the process described above.

FIG. 8 illustrates an example communication flow between a user device 804 and a virtual access device 802 on a vehicle 800 according to some embodiments. The steps in FIG. 8 can occur in step S20 in the flow described above with respect to FIG. 7. User device 804 can be a payment card, a mobile phone, a secure element in the electric vehicle 103, etc.

Virtual access device 802 can be emulated, for example, based on an access device profile obtained from an actual access device such as an actual point of sale (POS) terminal. The communications can be in the form of application commands sent from virtual access device 802 and application data responses sent from user device 804 in response to the application commands. In some embodiments, the application commands and data responses can be in the form of APDU commands and responses. However, it should be understood that other messages, messaging protocols, or formats can be used to exchange the application data to conduct the transaction.

To initiate the application data exchange, virtual access device 802 may initiate a transaction by sending an available applications request S802 to user device 804 to request information as to which payment application identifier(s) (AID(s)) may be available. Each AID may correspond to an account of the user and/or processing options associated with an account. In some embodiments, the available application(s) request S802 may be in the form of a select PPSE command. The available applications request S802 may include a payment environment identifier (e.g., a PPSE name) to identify the payment environment supported by virtual access device 802.

Upon receiving the available applications request S802, user device 804 may identify and process the request by recognizing the payment environment identifier (e.g., PPSE name) included in the request, and respond by sending an available applications response S804 back to virtual access device 802. The available applications response S804 may include a list of available AIDs, and may include the payment environment identifier (e.g., PPSE name) as the dedicated file name. In some embodiments, the available applications response S804 may be in the form of a select PPSE response and may include PPSE file control information (FCI). For example, the available applications response S804 may include a directory entry for each available AID. If user device 804 supports only one AID, user device 804 may respond with a single directory entry for the supported AID. If user device 804 supports an account with multiple AIDs, the transaction application may respond with a directory entry for each of the supported AIDs. Each directory entry may include information such as the AID, an application label associated with the AID (e.g., a mnemonic associated with the AID), an application priority indicator indicating the priority of the AID, a kernel identifier indicating the application's kernel preference, and/or additional information relating to the particular AID. The available application(s) response S804 may also include other data such as FCI issuer discretionary data.

When virtual access device 802 receives the available applications response S804, virtual access device 802 may select a suitable application from the list of applications received in the available applications response S804 (e.g., by selecting an AID from the available AID(s) received in the available application(s) response S804). In some embodiments, the selected AID can be the highest priority AID on a prioritized list of application identifiers supported by the access device being emulated by virtual access device 802. The prioritized list of application identifiers can be obtained as part of the access device profile. Virtual access device 802 may send an application selection S806 with the selected AID to user device 804 to continue the transaction. In some embodiments, the application selection S806 can be in the form of a select AID command.

Upon receiving the application selection S808, user device 804 may send a terminal transaction data request 808 to request transaction data from virtual access device 802 to execute the transaction using the selected application/AID. In some embodiments, the terminal transaction data request S808 may be in the form of a select AID response and may include AID file control information (FCI) with the selected AID as the dedicated file name. The terminal transaction data request S808 may include a list of transaction data identifiers to request the appropriate data from virtual access device 802, and the list of transaction data identifiers can be in the form of a processing options data object list (PDOL). The transaction data requested by user device 804 for the transaction may include terminal transaction qualifiers (TTQ), authorized amount, other amount, terminal country code, terminal verification results, transaction currency code, transaction data, transaction type, and/or an unpredictable number. The terminal transaction data request 808 may also include other data such as FCI issuer discretionary data, application program identifier, and language preference.

After receiving the terminal transaction data request 808, virtual access device 802 may send to user device 804, the terminal transaction data S810 requested by user device 804. The terminal transaction data S810 provided by virtual access device 802 can be obtained from the access device profile. In some embodiments, the terminal transaction data 810 may be sent in the form of a get processing options (GPO) command, and may include the requested terminal transaction data in a processing options data object list (PDOL). In some embodiments, the terminal transaction data S810 (e.g., terminal transaction qualifiers (TTQ)) may include a transaction type indicator indicating the type of transaction supported by the access device. In some embodiments, the terminal transaction data S810 (e.g., terminal transaction qualifiers (TTQ)) may also include a consumer verification method (CVM) requirement indicator to indicate whether a CVM is required by the access device for the transaction, and also one or more CVM type indicators indicating the types of CVM supported by the access device. Examples of CVMs that may be supported by the access device can include online PIN, signature, and/or consumer device CVM (CDCVM) such as a passcode to unlock the screen or user device 804.

Once the user device 804 receives terminal transaction data S810, user device 804 may increment its Application Transaction Counter (ATC), generate dynamic transaction processing information using at least some of the received terminal transaction data 810, and send a set of transaction processing information S812 including the generated dynamic transaction processing information to virtual access device 802. In some embodiments, the transaction processing information S812 can be sent in the form of a GPO response. In some embodiments, the transaction processing information S812 may include one or more application file locators (AFLs) that can be used as file address(es) by virtual access device 802 to read account data stored on user device 804, and an application interchange profile (AIP) that can be used to indicate the capabilities of user device 804.

In some embodiments, the AFLs included in transaction processing information S812 may include file addresses to read account data such as a transaction cryptogram dynamically generated using a limited-use key (LUK) and/or unpredictable number from the access device, track-2 equivalent data including a token or a PAN, and addition data such as issuer application data (IAD), form factor indicator (FFI), card transaction qualifiers (CTQ), cryptogram information data (CID), the updated ATC, and/or an application PAN sequence number (PSN). In some embodiments, the issuer application data (IAD) may include a length indicator indicating the length of the IAD, cryptogram version number (CVN) indicating the version of the transaction cryptogram, a derived key indicator (DKI) that can be used to identify a master key (e.g. a master key associated with the issuer used in generation of the LUK), card verification results (CVR), a wallet provider ID, and/or derivation data such as the key index that was used in the generation of the LUK. In some embodiments, transaction processing information S812 may include the above account data themselves instead of their corresponding AFLs, or a combination thereof. It should also be understood that in some embodiments, the transaction processing information S812 being sent from user device 804 to virtual access device 802 may include some or all of the information describe above, and in some embodiments, may include additional information not specifically described.

After virtual access device 802 receives the transaction processing information S812, virtual access device 802 may send an account data request S814 to user device 804 to read additional account data that may be stored on the user device 804. In some embodiments, the account data request S814 may be in the form of a read record command, and may include an application file locator (AFL) indicating the location of the account data that virtual access device 802 is attempting to read. The AFL included in the account data request S814 may correspond to an AFL in the transaction processing information S812 that was provided to virtual access device 802 from user device 804.

In response to receiving the account data request S814 from virtual access device 802, user device 804 may send the account data 816 stored at the location indicated by the AFL to virtual access device 802. In some embodiments, the account data 816 may be sent in the form of a read record response. The account data 816 may include, for example, the account data elements discussed above (e.g., a PAN, token, CVV, etc.), and/or application usage control that indicates the issuer's restrictions on the usage and services allowed for the application, the cardholder's name, customer exclusive data, issuer country code, token requester ID (e.g., if a token is used), and/or other account related data that is accessible at the AFL location. It should be understood that in some embodiments, the account data 816 being sent from user device 804 to virtual access device 802 may include some or all of the information describe above, and in some embodiments, may include additional information not specifically described.

In some embodiments, there can be more than one pair of account data request S814 and account data 816 communication exchange between virtual access device 802 and user device 804. Once virtual access device 802 has received the requisite data from the transaction processing information S812 and/or one or more account data 816 transmissions, some or all of the data elements in the transaction processing information S812 and/or one or more account data 816 transmissions can be concatenated by virtual access device 802 to form a data packet. The data packet may include a checksum and a packet length indicator to indicate the length of the data packet. The data packet can be used by the virtual access device to generate a transaction authorization request message to request authorization of the transaction from the issuer. For example, in some embodiments, the transaction authorization request message may include at least the track-2 equivalent data including a token or PAN, and the transaction cryptogram generated with the LUK, and the transaction can be authorized based on at least verifying that the transaction cryptogram was generated correctly and that the LUK used in generation of the transaction cryptogram has not exhausted the LUK's set of one or more limited use thresholds.

Other embodiments of the invention can include other devices, computers and methods.

Another embodiment of the invention includes a method comprising: establishing a communication session between a vehicle comprising a first processor and an energy supply terminal comprising a second processor via a cable that is adapted to supply energy from the energy supply terminal to the vehicle; receiving, by the energy supply terminal from the vehicle for an energy supply cable, an encrypted data packet including the credential or token; and transmitting, by the energy supply terminal to a service provider computer, the encrypted data packet, which decrypts the encrypted data packet to obtain the credential or token, and then processes a transaction for supplying the vehicle with energy using the credential or the token.

Another embodiment of the invention includes an energy supply terminal comprising: a processor; and a computer readable medium coupled to the processor, the computer readable medium comprising code for causing the processor to perform operations including: establishing a communication session between a vehicle comprising a first processor and the energy supply terminal via a cable that is adapted to supply energy from the energy supply terminal to the vehicle; receiving, by the energy supply terminal from the vehicle for an energy supply cable, an encrypted data packet including the credential or token; and transmitting, by the energy supply terminal to a service provider computer, the encrypted data packet, which decrypts the encrypted data packet to obtain the credential or token, and then processes a transaction for supplying the vehicle with energy using the credential or the token.

Embodiments of the invention provide for a number of technical advantages. Using embodiments of the invention, energy supply terminals need not be retrofit with specialized hardware or software for a user to conveniently obtain energy from energy supply terminals for the user's vehicle. Further, in the context of electric car charging, the user can simply “plug and go” when charging an electric vehicle. In some embodiments, the user need not take active steps to pay for charging of the user's vehicle. Further, sensitive data such as payment credentials and payment tokens are protected as they are passed from the electric vehicle to a service provider computer. As such, the energy supply terminals (e.g., charging stations) need not be provided with special software and hardware to provide data security for the sensitive data.

Other embodiments have advantages including allowing for the users of vehicles to pre-authorize amounts more accurately in accordance with the amount of energy that they may actually obtain. The benefit of this is that there is no need to unnecessarily hold excess amounts in the users' accounts when obtaining energy for their vehicles.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
establishing a communication session between a vehicle comprising a first processor and an energy supply terminal comprising a second processor;
obtaining, by the first processor in the vehicle, a credential or token,
generating, by the first processor in the vehicle, an encrypted data packet including the credential or token; and
providing, by the first processor in the vehicle, the encrypted data packet to the energy supply terminal, wherein the energy supply terminal transmits the encrypted data packet to a service provider computer, which decrypts the encrypted data packet to obtain the credential or token, and then processes a transaction for supplying the vehicle with energy using the credential or the token.

2. The method of claim 1, wherein the energy is electricity, the vehicle is an electric vehicle that comprises a battery system that comprises a battery, the energy supply terminal is an electricity supply terminal, and wherein the communication session between the vehicle and the energy supply terminal is via a cable in the form of an electrical charging cable, and the encrypted data packet is provided by the first processor in the vehicle to the energy supply terminal via the electrical charging cable.

3. The method of claim 2, wherein the service provider computer processes the transaction by generating an authorization request message comprising the credential or token and a value associated with supplying the electricity to the electric vehicle.

4. The method of claim 3, wherein the electric vehicle is an electric car.

5. The method of claim 2, wherein obtaining the credential or the token comprises:
receiving the credential or the token from a user device held by a user of the electric vehicle.

6. The method of claim 2, wherein obtaining the credential or the token comprises:
retrieving the credential or the token from a memory in a user device that is separate from the electric vehicle.

7. The method of claim 2, further comprising, prior to obtaining the credential or token:
transmitting, by the electric vehicle to the electricity supply terminal, a service discovery request;
receiving, by the electric vehicle from the electricity supply terminal, a service discovery response comprising a list of available services;
determining, by the electric vehicle, a set of services in the list of available services, wherein the set of services includes services supported by the electric vehicle;
transmitting, by the electric vehicle to the electricity supply terminal, a service detail request comprising indicators for the set of services;
receiving, by the electric vehicle from the electricity supply terminal, a service detail response comprising electricity supply terminal data and a service provider computer digital certificate associated with a service provider computer that is in communication with the electricity supply terminal;
transmitting, by the electric vehicle to the electricity supply terminal, a service selection request comprising a service in the set of services;
receiving, by the electric vehicle from the electricity supply terminal, a service selection response;
transmitting, by the electric vehicle to the electricity supply terminal, an interaction details request comprising an electric vehicle digital certificate;
receiving, by the electric vehicle from the electricity supply terminal, an interaction details response comprising a challenge; and
signing, by the electric vehicle, the challenge using a private key associated with a public key in the electric vehicle digital certificate to form a signed challenge.

8. The method of claim 7, wherein providing the encrypted data packet to the electricity supply terminal via the cable comprises providing an authorization request message comprising the encrypted data packet to the electricity supply terminal, wherein the electricity supply terminal transmits the authorization request message comprising the encrypted data packet and the signed challenge to the service provider computer, which decrypts the encrypted data packet to obtain the credential or token, and then processes the transaction for supplying the electric vehicle with energy by modifying the authorization request message to include the credential or the token and transmitting the modified authorization request message to an authorizing entity computer for authorization.

9. The method of claim 8, wherein the authorization request message further comprises an estimated amount of electricity to fill the battery, which is determined by the electric vehicle.

10. The method of claim 8, further comprising:
receiving, by the electric vehicle, the electricity supply terminal, a transaction response to the authorization request message; and
receiving, by the electric vehicle from the electricity supply terminal, electricity from the electricity supply terminal.

11. The method of claim 2, wherein providing the encrypted data packet to the electricity supply terminal via the cable comprises providing an authorization request message comprising the encrypted data packet to the electricity supply terminal, wherein the electricity supply terminal transmits the authorization request message comprising the encrypted data packet and a signed challenge to the service provider computer, which decrypts the encrypted data packet to obtain the credential or token, and then processes the transaction for supplying the electric vehicle with energy by modifying the authorization request message to include the credential or the token and transmitting the modified authorization request message to an authorizing entity computer for authorization.

12. The method of claim 2, wherein providing the encrypted data packet to the electricity supply terminal via the cable comprises providing an authorization request message comprising the encrypted data packet to the electricity supply terminal, wherein the electricity supply terminal transmits the authorization request message comprising the encrypted data packet and a signed challenge to the service provider computer, which decrypts the encrypted data packet to obtain the credential or token, and then processes the transaction for supplying the electric vehicle with energy by modifying the authorization request message to include the credential or the token and transmitting the modified authorization request message to an authorizing entity computer for authorization, and wherein the method further comprises:
generating, by a virtual access application in the electric vehicle, the authorization request message.

13. The method of claim 12, wherein the virtual access application interacts with a user device external to the electric vehicle to obtain the credential or the token.

14. The method of claim 2, wherein the token is obtained.

15. A vehicle comprising:
a first processor; and
a computer readable medium, the computer readable medium comprising code executable by the first processor to cause the first processor to perform operations including:
establishing a communication session between the vehicle and an energy supply terminal comprising a second processor;
obtaining a credential or token,
generating an encrypted data packet including the credential or token; and
providing the encrypted data packet to the energy supply terminal.

16. The vehicle of claim 15, wherein the energy is electricity, the vehicle is an electric vehicle that comprises a battery system that comprises a battery, the energy supply terminal is an electricity supply terminal, and wherein the communication session is conducted via a cable that is an electrical charging cable, and the encrypted data packet is provided by the first processor in the vehicle to the energy supply termina via the electrical charging cable.

17. The vehicle of claim 16, wherein providing the encrypted data packet to the electricity supply terminal via the cable comprises providing an authorization request message comprising the encrypted data packet to the electricity supply terminal, and wherein the operations further comprise:
generating, by a virtual access application on the computer readable medium in the vehicle, the authorization request message.

18. The vehicle of claim 16, wherein the operations further comprise:
receiving from the electricity supply terminal, a transaction; and
receiving, by the electric vehicle from the electricity supply terminal, electricity from the electricity supply terminal.

19. A method comprising:
receiving, by a service provider computer, an encrypted data packet from a vehicle via an energy supply terminal;
decrypting, by the service provider computer, the encrypted data packet to obtain a credential or token; and
processing a transaction for supplying the vehicle with the energy using the credential or the token.

20. The method of claim 19, wherein the energy is electricity, the vehicle is an electric vehicle that comprises a battery system that comprises a battery, the energy supply terminal is an electricity supply terminal, and wherein the encrypted data packet is received from the vehicle via a cable, the cable being an electrical charging cable.

21.-30. (canceled)
